(19) United States
(12) Patent Application Publication
(10) Pub. No.: US 2009/0208832 A1
(43) Pub. Date: Aug. 20, 2009

(54) Lamination Configurations for Battery Applications Using PVDF Highly Porous Film

(75) Inventor: Kirby Beard, Norristown, PA (US)

Correspondence Address: Porous Power Technologies-Correspondence, Krajec Patent Offices, LLC, 820 Welch Ave, Berthoud, CO, 80513, US

(73) Assignee: Porous Power Technologies, LLC, Louisville, CO (US)

(21) Appl. No.: 12/372,706

(22) Filed: Feb. 17, 2009

Related U.S. Application Data
(60) Provisional application No. 61/029,367, filed on Feb. 17, 2008.

(51) Int. Cl. H01M 2/18; B65H 81/00

(52) U.S. Cl. 429/131; 156/194

(57) ABSTRACT

A porous material manufactured Polyvinylidene Difluoride, or PVDF may be used in several configurations as a separator material for Lithium Ion and other types of batteries. The PVDF separator may be used with electrodes manufactured from a PVDF substrate for various lamination techniques in various configurations. The PVDF separator may be used in several configurations to enable more active material into a given battery construction, ensure better adhesion between layers, and overall increase the performance and capacity of a battery.

### BACKGROUND

Batteries are often manufactured from an anode and cathode, separated by a separator that may contain electrolyte. Various manufacturing processes for batteries may be used to create cylindrical batteries, flat batteries, or other shaped batteries.

### SUMMARY

A porous material manufactured Polyvinylidene Difluoride, or PVDF may be used in several configurations as a separator material for Lithium Ion and other types of batteries. The PVDF separator may be used with electrodes manufactured from a PVDF substrate for various lamination techniques in various configurations. The PVDF separator may be used in several configurations to enable more active material into a given battery construction, ensure better adhesion between layers, and overall increase the performance and capacity of a battery.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a schematic illustration of an embodiment showing a first assembly of an electrode and separator.

FIG. 2 is a schematic illustration of an embodiment showing a second assembly of an electrode and separator.

FIG. 3 is a schematic illustration of an embodiment showing a third assembly of an electrode and separator.

FIG. 4 is a schematic illustration of an embodiment showing a fourth assembly of an electrode and separator.

FIG. 5 is a schematic illustration of an embodiment showing an assembly of two electrode and separator pairs.

FIG. 6 is a schematic illustration of an embodiment showing a fifth assembly of an electrode and separator.

FIG. 7 is a schematic illustration of an embodiment showing a sixth assembly of an electrode and separator.

FIG. 8 is a schematic illustration of an embodiment showing a seventh assembly of an electrode and separator.

FIG. 9 is a schematic illustration of an embodiment showing an assembly of multiple electrodes and separators.

FIG. 10 is a flowchart illustration of an embodiment showing a method for manufacturing a porous material.

FIG. 11 is a flowchart illustration of an embodiment showing a method for manufacturing a battery.

### DETAILED DESCRIPTION

Batteries, including lithium ion batteries, may be constructed of layers of electrodes and separators. The electrodes, either anodes or cathodes, may be laminated to separators using various configurations of separators, and the laminations may be further laminated or merely placed next to other electrodes to create a battery.

A battery may be formed by alternating layers of anodes and cathodes with separator placed between the anodes and cathodes. The separator may serve to place the electrodes apart from each other and to capture electrolyte. The electrolyte may enable ions to move from one electrode to another during charging or discharging operations. When an anode comes in contact with a cathode, the battery may short, causing failure or a large reduction in capacity.

The embodiments illustrated herein may be used for any type of battery chemistry and any type of battery geometry, including flat geometries and wound geometries. Flat geometries are generally manufactured by stacking several layers of electrodes and separators. Wound geometries are generally manufactured by winding a stack of layers that may include a separator, one electrode, a second separator, and a second electrode. Some wound geometries are round, while other wound geometries may be elliptical or other shapes.

Specific embodiments of the subject matter are used to illustrate specific aspects. The embodiments are by way of example only, and are susceptible to various modifications and alternative forms. The appended claims are intended to cover all modifications, equivalents, and alternatives falling within the spirit and scope of the invention as defined by the claims.

In some battery constructions, some difficulties may arise at the edges of the electrodes. In many embodiments, extra separator material may be placed at the edges to insulate the edges from shorting and to lower dendrite growth in some battery chemistries. Dendrite growth may be significantly slowed or eliminated by insulating the edges of an electrode while enabling as much active material as possible to be housed in a battery volume.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled”, there are no intervening elements present.

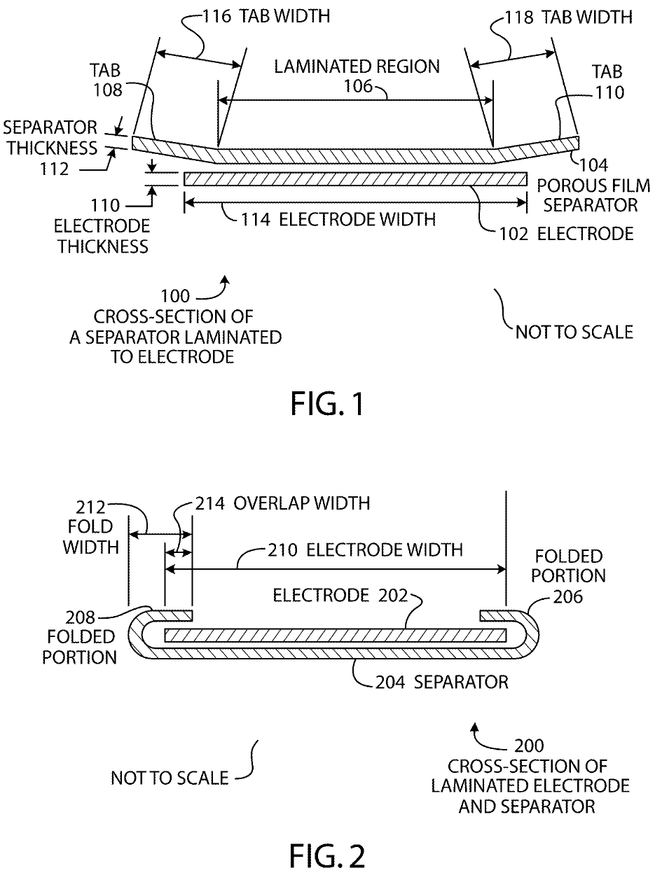

FIG. 1 is a schematic diagram of an embodiment 100 showing a cross section of a separator laminated to an electrode. An electrode 102 is shown with a porous film separator 104. The separator 104 may be laminated or bonded in the region 106 to the electrode 102, leaving two unbounded tabs 108 and 110. In a typical embodiment, such as a wound battery construction, the tabs 108 and 110 may be continuous areas of unbounded separator material.

The porous film separator 104 may be bonded to the electrode 102 across the region 106 while avoiding heat bonding at the edges near the unbonded tabs 108 and 110. Such an embodiment may be useful when the electrode 102 has sharp edges that may penetrate, pierce, or otherwise weaken the separator 104, possibly causing a short to an adjacent electrode, or when using separator material that is susceptible to being pierced or torn during manufacturing.

In many embodiments, good heat bonding may be achieved when the separator 104 is manufactured from PVDF using a porous film manufacturing process described later in this specification. In some embodiments, the separator 104 may be infused with electrolyte at the time the bonding occurs, and in other embodiments, an electrolyte may be added after bonding.

The laminated or bonded region 106 may be achieved by heat lamination, adhesive bonding, or some other bonding method. In some cases, mechanical bonding may be possible using pressure at room temperature, while in other cases ultrasonic, microwave, or other energy source may be applied as well.

Embodiment 100 may illustrate one step in a manufacturing process for a multiple layer battery. Further steps in the battery construction may include layering anode and cathode electrodes in a stack or winding the layers around a mandrel.

Subsequent steps may include folding or wrapping the tabs 108 and 110 around the ends of the electrode 102, as illustrated in FIG. 2.

Embodiment 100 illustrates an electrode 102 having an electrode width 114, and a separator 104 having a width comprising the sum of the laminated region 106 and the tab widths 116 and 118.

Embodiment 100 may illustrate a cross section of two different types of battery configurations: cylindrical and flat. In a typical configuration, the electrode 102 may be an anode or cathode, which may be separated from the neighboring electrode by the separator 104.

In a cylindrical cell configuration, a sandwich of an anode, a first separator, a cathode, and a second separator may be wound around a mandrel to create a prismatic or cylindrical cell. The center mandrel may act as a conductor for the battery. In such embodiments, the electrodes and separators may be formed from long strips of material, the cross section of which may be illustrated by embodiment 100. The ends of the cross section at the tabs 108 and 110 may correspond with the top and bottom of a cylindrical battery.

In a flat configuration, planar sheets of electrodes and separators may be stacked together to form a battery. In many flat configurations, multiple layers of electrodes and separators may be stacked together to form a battery, sometimes several hundreds of layers. In a flat configuration, the cross section of embodiment 100 may represent a cross section of any portion of a flat electrode, such as through the width or length of a rectangular shaped flat battery configuration.

The electrode width 114 may be any width, depending on the battery configuration. In a typical embodiment, the electrode width may be from 1 cm to 50 cm or larger. In some embodiments, the laminated region 106 may be as wide as the electrode width 114. In such cases, the full width of the electrode 102 may be laminated to the separator 104.

In other embodiments, the laminated region 106 may be a relatively narrow region, such as a laminated region that is ten percent or less of the electrode width 114. In such embodiments, the laminated region may be a narrow strip that may mechanically join the separator 104 and the electrode together for ease of handling through various process machines. Such embodiments may have discontinuous spots or laminated regions, or may have a continuous narrow laminated region.

Different mechanisms may be used to join the separator 104 to the electrode 102 in the laminated region 106. In the case of a cylindrical battery configuration, the lamination may be performed using rolling mechanisms that may process long strips of electrodes and separators. For example, a heated roller against the separator may apply heat through the thickness of the separator to cause a bond with the electrode 102.

In another example, heat may be applied to the surface of the separator 104 and/or the surface of the electrode 102 prior to applying mechanical pressure to the separator and electrode. Such a process may be performed for either cylindrical batteries using a pinch roller mechanism or for flat battery configurations using a flat press.

In some embodiments, mechanical pressure may form a sufficient bond between a porous film separator 104 and an electrode 102 without applying heat or by applying enough heat to soften but not melt the separator 104.

In some embodiments, the laminated region 106 may be created to enhance contact between the separator 104 and the electrode 102. A fully laminated sandwich of the separator 104 and electrode 102 may control the thickness of the separator/electrode laminate so that multiple laminates may be placed together to create a battery having a predetermined thickness.

The separator tabs 108 and 110 may be folded over the ends of the electrode 102. By folding the separator 104 over one or more ends or edges of the electrode 102, dendrite growth at the electrode edges may be minimized. In some embodiments, the separator width may be such that a small amount of separator material may be folded over an electrode edge, forming an overlap width of 1 to 2 mm on what would be the lower surface of the electrode in the view shown in FIG. 1. In other embodiments, the separator material may be folded over to form an overlap width that encompasses the entire width of the bottom surface of the electrode 102.

In an embodiment of a cylindrical battery, the separator and electrode materials may be presented to a winding apparatus as relatively long, thin strips. The length of the strips may be wound around a mandrel approximately the same width as the strips. At the leading edge or trailing edge of the strips, an excess amount of separator 104 may be created as the tab 110. The tab 110 may be folded over the leading edge of the electrode 102 and fed into the winding machinery. The extra separator material at the leading edge of the strip may ensure that a short or excess dendrite growth does not occur at the end of the electrode that may engage the winding mandrel. In an embodiment where a tab 108 is formed at the trailing edge of a strip to be wound, the tab 108 may be folded over the trailing edge of the electrode 102 or left unfolded.

In a battery manufacturing process, a manufacturer may produce an intermediate assembly of an electrode 102 and a separator 104. The intermediate assembly may be separately manufactured, stored, and then mated with an anode or cathode assembly to create a battery pack.

The term ‘tabs’ as used in this specification and claims refers to separator material that may be larger than the electrode. The term ‘tabs’ is not used to refer to metal current collectors that may be attached to electrodes.

FIG. 2 is a schematic diagram of an embodiment 200 showing a cross section of a separator laminated to an electrode. An electrode 202 is shown with a separator 204 that has a folded portion 206 and 208 around the edges of the electrode 202.

Embodiment 200 illustrates the components that may be laminated together to form an intermediate assembly for a battery. For illustration purposes, the components are shown some distance apart from each other. In many embodiments, the components may be laminated together using various processing methods to form a sandwich that may be approximately a constant thickness. In many embodiments, the separator material may be highly porous and may be compressed to varying degrees.

In some cases, a lamination process may apply heat to the mass of the separator material and may permanently deform the separator material to achieve a constant thickness. In other cases, a lamination process may apply mechanical pressure or surface heating of the separator material to affect a bond, but the separator material may not be permanently deformed to achieve a constant thickness. In such cases, the separator material may compress when compressed against a second electrode that is similarly configured with separator material during the assembly process for a battery.

Embodiment 200 may illustrate an assembly of an electrode 202 and separator 204 that may be assembled and heat laminated together in one or more steps.

In some embodiments, the separator 204 may be placed next to the electrode 202 and the folded portions 206 and 208 may be wrapped around the electrode 202. The folded assembly may be heat laminated by a flat plate, heated rollers, or some other lamination technique.

In some embodiments, a construction similar to embodiment 100 may be created using a first lamination step, then the folded portions 206 and 208 may be created from the tabs 110 and 108, respectively, and a second lamination step may be performed.

Some embodiments may use a porous PVDF film as a separator. Such films may have good flexibility and conformability to withstand the folding process, and may readily bond to some electrodes without a large amount of pressure, time or temperature. Some separator materials, when subjected to large pressures and/or high temperatures, may permanently deform.

In many embodiments, some deformation may occur, even with PVDF separators. The deformation may crush pores in a separator film and block the ion transfer across a separator. Such blockage may reduce a battery's effectiveness. By reducing the amount of pressure and temperature applied to achieve an effective bond, less deformation may result.

The folded portions 206 and 208 may provide insulation or protection for the edges of an electrode 204. The insulation may protect against the electrode shorting against a battery case or against the edges of a neighbor electrode. The additional insulation at the edges of the electrode may reduce the potential for dendrite growth in a battery.

The width of the separator 204 may be greater than the width of the electrode 202 by 1 or 2 centimeters prior to forming the folded portions 206 and 208 in some embodiments. Other embodiments may use greater or smaller amounts of excess material to form the folded portions 206 and 208.

In various battery constructions, a folded portion 206 may be created for any edge of an electrode. In a wound construction, a folded portion 206 may be created for the leading and trailing edges of the wound laminate, as well as the edges of the laminate perpendicular with the winding axis. In a flat battery construction, all four edges of an electrode may be protected by a folded portion of separator.

Embodiment 200 is an example of an electrode 202 and a separator 204 that may be formed from an intermediate assembly such as the embodiment 100. The intermediate assembly of embodiment 100 may be formed by laminating all or part of the electrode 202 to the separator 204. A second stage of processing may form the folded portions 206 and 208. In some embodiments, a second lamination process may be applied to the intermediate assembly as shown in the cross section of embodiment 200.

Embodiment 200 shows the electrode 202 having an electrode width 210 and the separator having a fold width 212 that may create an overlap width 214. The electrode width 210 may be any width, as described above, and the overlap width may be a distance from a millimeter to half of the electrode width 210. When the overlap width 214 is half of the electrode width 210, the separator 204 may encase the electrode 202. In some such embodiments, a small gap between the edges of the separator 204 may be included for manufacturing tolerance.

In some embodiments, the fold width 212 may be substantially larger than the overlap width 214, leaving an area within the folded portion 208 where the electrode 202 does not extend. In such embodiments, the fold width 212 may be several millimeters larger than the overlap width 214. The larger fold width 212 may be used to insulate the ends of the electrode 202 in some battery configurations.

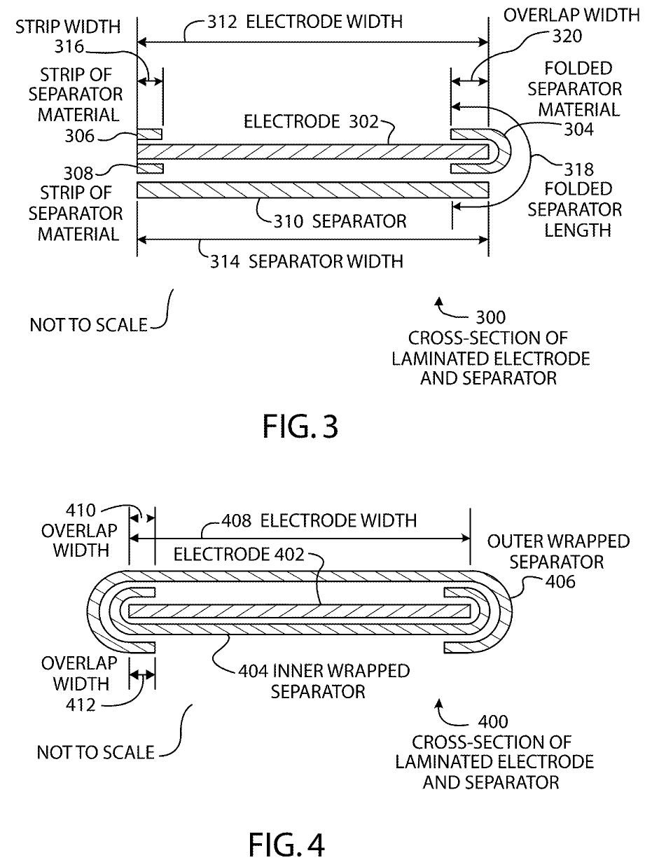

FIG. 3 is a schematic diagram of an embodiment 300 showing a cross section of a separator laminated to an electrode. An electrode 302 is shown with a separator 310, and a folded separator material 304 around one end and strips of separator material 306 and 308 on another.

Embodiment 300 illustrates two designs for adding additional insulation at the edges of an electrode. In one design, a folded strip of separator material 304 may be attached to the electrode 302 prior to or simultaneous with the attachment of the separator 310. The separator 310 and folded strip of separator material 304 may be attached using heat lamination, adhesive lamination, or any other attachment mechanism.

Embodiment 300 illustrates the components that may be laminated together to form an intermediate assembly for a battery. For illustration purposes, the components are shown some distance apart from each other. In many embodiments, the components may be laminated together using various processing methods to form a sandwich that may be approximately a constant thickness. In many embodiments, the separator material may be highly porous and may be compressed to varying degrees.

In some cases, a lamination process may apply heat to the mass of the separator material and may permanently deform the separator material to achieve a constant thickness. In other cases, a lamination process may apply mechanical pressure or surface heating of the separator material to affect a bond, but the separator material may not be permanently deformed to achieve a constant thickness. In such cases, the separator material may compress when compressed against a second electrode that is similarly configured with separator material during the assembly process for a battery.

Similarly, the strips of separator 306 and 308 may be used to add insulator material to an edge of the electrode 302. In some embodiments, the strips 306 and 308 may extend past the edge of the electrode 302 and may be bonded to each other. The strips 306 and 308 may be attached to the electrode in sequence with the separator 310 or simultaneously with the separator 310. In some embodiments, the strips 306 and 308 may be applied simultaneously and the separator 310 may be applied subsequently.

In some cases, the separator 310 may be a different thickness material than the folded separator 304 or the strips 306 and 308. In some embodiments, the separator 310 may be substantially thinner or thicker than the folded separator 304 or the strips 306 or 308.

Embodiment 300 is an example of two different designs. In many embodiments, a folded separator material 304 may be applied to two, three, or four edges of an electrode, while other embodiments may apply strips 306 and 308 on two, three, or four edges of an electrode.

Some constructions may use a single strip 306 or 308 in conjunction with a separator 310.

Embodiment 300 illustrates the electrode width 312 and the separator width 314 being approximately equal. On the left side, two strips 306 and 308 having a strip width 316 are illustrated. Some embodiments may use just the strip 306 and omit strip 308, and some embodiments may include strip 308 and omit strip 306.

The strip width 316 may be very narrow, such as a millimeter or less, or may be several millimeters or several centimeters in width.

The addition of extra separator material in strips at the edge of an electrode may slow down or inhibit the operation of the electrode 302, minimizing dendrite growth and potential for shorting.

In some embodiments, the electrode 302 and separator 310 may be laminated or bonded together in a first operation, and the strip 306 may be added in a subsequent operation. One such manufacturing process may laminate wide strips of electrode 302 and separator 310 that may be an integer multiple of a width of a battery. The wide laminate may be slit into several laminations and the strip 306 may be applied on one, two, three, or four edges of a laminate.

For example, a wide sheet of separator 310 and electrode 302 may be laminated together. Such a sheet may be 50 cm wide, for example. In order to make cylindrical batteries that are approximately 10 cm tall, the sheet may be slit into 10 cm widths and the strip 306 may be applied as a secondary operation. In some embodiments, the strip 306 may be applied to a leading edge or trailing edge of a wound strip of laminate. In some embodiments, the strip 306 may be applied to one or both of the edges perpendicular to the axis of winding.

On the right side of the illustration of embodiment 300, a folded separator 304 is illustrated as having a folded separator length 318 and an overlap width 320. In embodiment 300, the folded separator 304 is illustrated as folding around the right end of the electrode 302, and then the separator 310 may be applied to the assembly. The overlap width 320 may be any dimension, from a millimeter or less to effectively covering the full electrode width 312.

In other embodiments, the folded separator 304 may be configured so that the folded separator 304 may be folded over both the electrode 302 and separator 310. Such an embodiment may be useful when a wide set of electrode and separator material are laminated then slit or cut into smaller pieces. The slit or cut pieces of laminate may have a folded separator 304 placed over one or more edges of the laminate, as described above for the strip 306.

Such a folded separator may be used on a leading or trailing edge of a wound strip of laminate for a cylindrical battery as well as one or both edges of such a strip.

FIG. 4 is a schematic diagram of an embodiment 400 showing a cross section of an electrode 404 wrapped with an inner separator 404 and an outer separator 406.

Embodiment 400 illustrates the components that may be laminated together to form an intermediate assembly for a battery. For illustration purposes, the components are shown some distance apart from each other. In many embodiments, the components may be laminated together using various processing methods to form a sandwich that may be approximately a constant thickness. In many embodiments, the separator material may be highly porous and may be compressed to varying degrees.

In some cases, a lamination process may apply heat to the mass of the separator material and may permanently deform the separator material to achieve a constant thickness. In other cases, a lamination process may apply mechanical pressure or surface heating of the separator material to affect a bond, but the separator material may not be permanently deformed to achieve a constant thickness. In such cases, the separator material may compress when compressed against a second electrode that is similarly configured with separator material during the assembly process for a battery.

Embodiment 400 may be used in a battery construction where both an anode and cathode may be wrapped using the construction of embodiment 400. In such a case, the anode and cathode may be separated by two layers of separator material. In other embodiments, one electrode may be wrapped as illustrated in embodiment 400 and may be assembled with another electrode that is unwrapped.

Embodiment 400 illustrates a different configuration of an electrode with wrapped edges than embodiment 200. Embodiment 400 may be constructed in one or more attachment or laminating steps.

In one process, a construction similar to embodiment 100 may be manufactured. A folding operation may be performed and a second lamination or bonding operation performed. A second layer of separator may be attached, then folded and a fourth bonding operation performed. Other assembly sequences may also be used.

Embodiment 400 illustrates a configuration where an electrode 402 having an electrode width 408 may be wrapped with two separators. An inner separator 404 may wrap the electrode 402 leaving an overlap width 410. An outer separator 406 may wrap the separator/electrode assembly and may form an overlap width 412. The overlap widths 410 and 412 may be small, such as two or three millimeters or less in width. In some embodiments, the overlap widths may be a centimeter or larger, and may in some cases extend to cover the full electrode width 408.

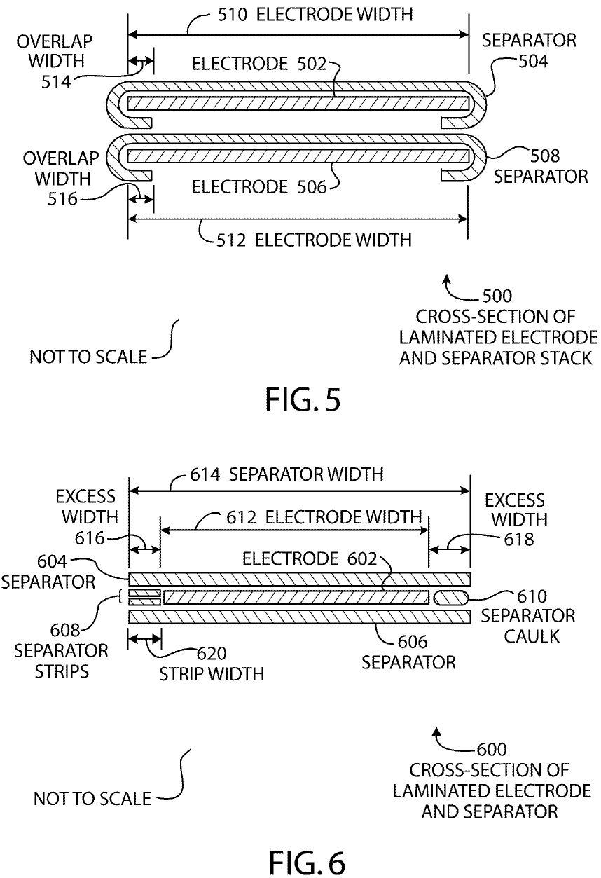

FIG. 5 is a schematic diagram of an embodiment 500 showing a cross section of an electrode 502 with a separator 504 and a second electrode 506 with a second separator 508. Embodiment 500 is an example of neighboring electrodes that may be each wrapped by a separator and bonded or laminated together.

Embodiment 500 illustrates the components that may be laminated together to form an intermediate assembly for a battery. For illustration purposes, the components are shown some distance apart from each other. In many embodiments, the components may be laminated together using various processing methods to form a sandwich that may be approximately a constant thickness. In many embodiments, the separator material may be highly porous and may be compressed to varying degrees.

In some cases, a lamination process may apply heat to the mass of the separator material and may permanently deform the separator material to achieve a constant thickness. In other cases, a lamination process may apply mechanical pressure or surface heating of the separator material to affect a bond, but the separator material may not be permanently deformed to achieve a constant thickness. In such cases, the separator material may compress when compressed against a second electrode that is similarly configured with separator material during the assembly process for a battery.

In some embodiments, a lamination process may not be used. The separators 504 and 508 may be mechanically wrapped around the electrodes 502 and 506, respectively, but not laminated or otherwise adhered together. In such embodiments, the sandwiched stack of electrodes and separators may be held together using a canister, such as in a wound cylindrical battery, or in other packaging.

In some embodiments, each electrode 502 and 506 may be laminated to a separator 504 and 508, respectively in a manner described for embodiment 200 above. The laminated electrode and separator assemblies may be further assembled to each other to form an intermediate construction step for a battery.

In some embodiments, the electrode 502 and 506 may be assembled with the separators 504 and 508 in an unbounded or unlaminated state, then the assembly of embodiment 500 may be laminated in a single step.

Embodiment 500 is another example of a configuration where a separator material may be folded around an edge of an electrode to provide additional insulation or protection from sharp edges of an electrode.

In many battery chemistries, such as lithium ion, a cathode may be constructed slightly smaller in size than an anode. Such designs may be used to control dendrite growth and to remove the potential for shorting to a metal container. Such designs may benefit from changing to a design such as embodiment 500, where the cathode may be the same width as an anode and thus a higher capacity battery may be formed in the same volume.

The extra separator material at the edges of the electrodes may have the effect of slowing ion transfer at the edges of the electrodes and thereby slowing dendrite growth.

Embodiment 500 illustrates electrode 502 having an electrode width 510 and being wrapped by a separator 504 having an overlap width 514. Electrode 506 has an electrode width 512 and is illustrated as being wrapped by separator 506 with an overlap width 516.

The overlap widths 514 and 516 may be small, such as two or three millimeters or less in width. In some embodiments, the overlap widths may be a centimeter or larger, and may in some cases extend to cover the full electrode width 510 or 512.

As illustrated, one of the electrodes 502 and 506 may be an anode and the other electrode may be a cathode. In some embodiments, one of the electrodes may be slightly narrower than the other. Other embodiments may use anodes and cathodes that are the same width.

The illustration of embodiment 500 may represent electrodes that may be manufactured for cylindrical batteries. In such batteries, a sandwich of anodes and cathodes, each wrapped with separator material, may be wound together around a mandrel to form a multilayer battery. In such an embodiment, the cross section of embodiment 500 may be a view perpendicular to the winding axis and the ends of the electrodes that are wrapped with separator material may be the top and bottom of a cylindrical battery.

In some embodiments of a wound cylindrical battery, the leading and/or trailing edges of the strips of electrodes may be wrapped with separator material. In such an embodiment, the illustration of embodiment 500 may be a cross sectional view that is parallel to the winding axis.

FIG. 6 is a schematic diagram of an embodiment 600 showing a cross section of an electrode 602 sandwiched between separators 604 and 606. At one end of the electrode 602, one or more separator strips 608 may be bonded between the separators 604 and 606. At the other end, a separator caulk 610 may be bonded between the separator 604 and 606.

Embodiment 600 illustrates the components that may be laminated together to form an intermediate assembly for a battery. For illustration purposes, the components are shown some distance apart from each other. In many embodiments, the components may be laminated together using various processing methods to form a sandwich that may be approximately a constant thickness. In many embodiments, the separator material may be highly porous and may be compressed to varying degrees.

In some cases, a lamination process may apply heat to the mass of the separator material and may permanently deform the separator material to achieve a constant thickness. In other cases, a lamination process may apply mechanical pressure or surface heating of the separator material to affect a bond, but the separator material may not be permanently deformed to achieve a constant thickness. In such cases, the separator material may compress when compressed against a second electrode that is similarly configured with separator material during the assembly process for a battery.

The separator strips 608 may be one or more layers of separator material that is assembled between the separators 604 and 606. In some embodiments, two or more separator strips 608 may be laminated together and assembled with the separators 604 and 608 to be laminated with the electrode 602.

The separator caulk 610 may be a preformed rope or other mass of separator material. The separator caulk 610 may be formed during a lamination process to squeeze between the separator 604 and 606 to seal the edges between the separators 604 and 606. In some embodiments, the separator caulk 610 may be applied as a paste, liquid, or gel and a porous structure may be formed in place during various stages of battery assembly.

Embodiment 600 illustrates an electrode 602 having an electrode width 612 and separators 604 and 606 having a separator width 614. The separator width 614 is shown as larger than the electrode width 612. On the left side of the illustration, separator strips 608 having a strip width 620 are placed between the separators 604 and 606 in the excess width 616 area. On the right side of the illustration, a separator caulk 610 is illustrated in the excess width 618 area.

The strip width 612 may be very narrow, such as a millimeter or less, or may be several millimeters or several centimeters in width. In some embodiments, two or more thicknesses of separator strips 608 may be used. In such embodiments, the multiple thicknesses of separator strips 608 may be crushed or deformed so that the void volume of the separator strips 608 is greatly diminished. For example, a set of separator strips with 80% voids may be crushed so that 10% or less voids remain. In some embodiments, the void volume within the area of the excess width 616 may be crushed or deformed to less than 5%, 2% or even 1%. Such a deformation may insulate the ends of the electrode to minimize dendrite growth and potential shorts.

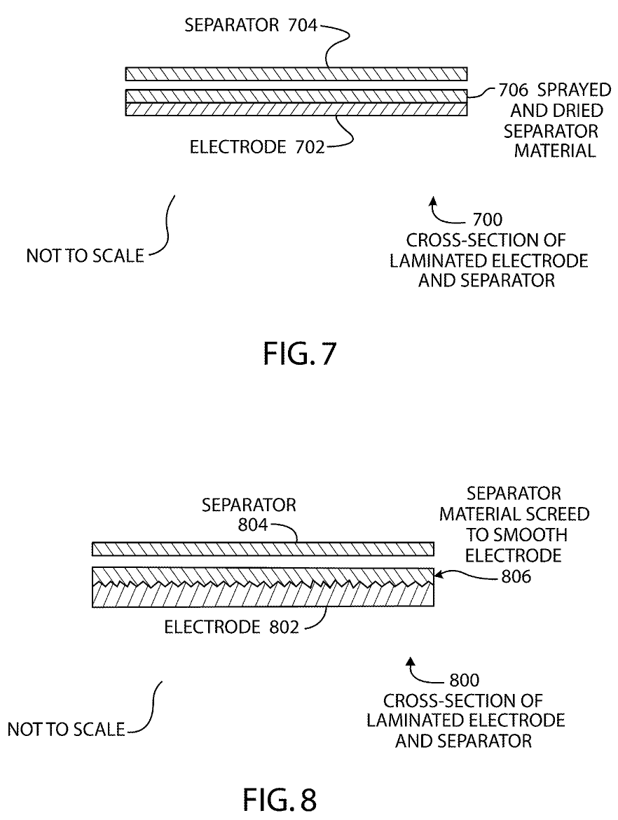

FIG. 7 is a schematic diagram of an embodiment 700 showing a cross section of an electrode 702 and a separator 704 wherein the electrode 702 may have some separator material 706 applied as a sizing or bonding agent. As described below, the separator may be formed of various formulations of a dissolved polymer and a pore forming liquid. In some cases, the material 706 may be the same or a compatible solvent as used to form the separator material 706.

In some embodiments, a light spray or other application of the liquid form of a separator material may be used to increase the adhesion of the separator 704 to the electrode 702. The liquid form of the separator material may be applied and processed so that a thin layer of porous separator material may be present on the electrode 702 prior to bonding the separator 704.

In some embodiments, the separator material 706 may be applied to both sides of the electrode 702 when the electrode 702 may be bonded between two separator layers.

FIG. 8 is a schematic diagram of an embodiment 800 showing a cross section of an electrode 802 and a separator 804 wherein the electrode 802 may have separator material 806 formed and screed, cut, ground, troweled, or otherwise used to fill or smooth any peaks and valleys on the electrode 802.

Embodiment 800 may be similar to embodiment 700 in many respects. In some electrodes used in lithium ion batteries, the surface of the electrode may be quite rough. The distance from a peak to a valley on the surface of the electrode may be as great or greater than the thickness of the separator 804. In such a case, a lamination process may result in a protrusion of the electrode 802 through the separator 804. Such a protrusion may result in a short to the neighboring electrode.

In some embodiments, the material 806 may be screed off or mechanically smoothed so that the separator 804 may not be punctured by a protrusion through the electrode 802.

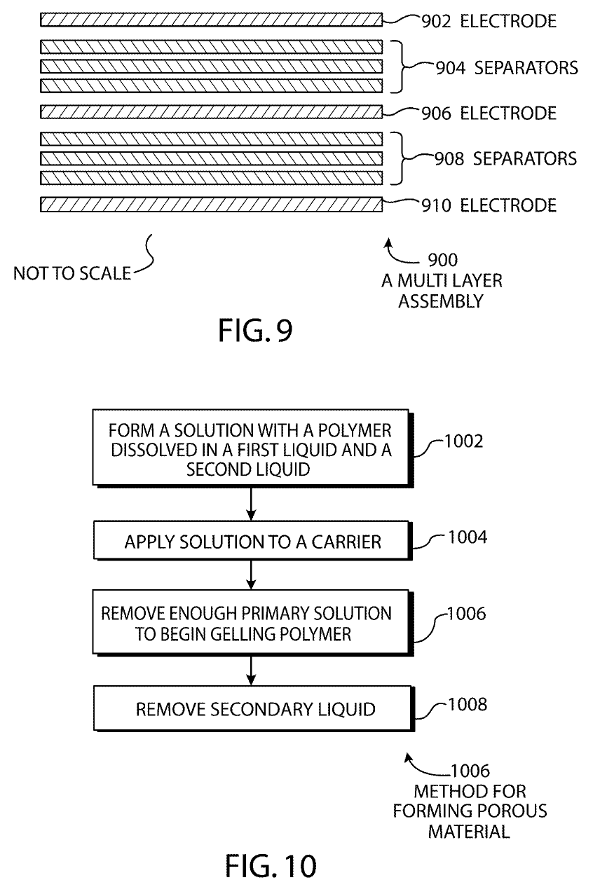

FIG. 9 is a schematic diagram of an embodiment 900 showing a cross section of a multilayer battery assembly. In the assembly, electrode 902 is bonded to several separators 904, electrode 906, several separators 908, and electrode 910.

In some embodiments, a single lamination process may be used to bond multiple layers of a battery assembly together. In many cases, 10 or more layers may be bonded in a single lamination process. The layers may consist of electrodes wrapped with separator and sometimes multiple layers of porous separator film.

When many layers are bonded together, flat pack battery assemblies may have increased performance and longevity than such assemblies that are assembled without monolithic bonding.

In some embodiments, one, two, three, or more layers of separator material may be used between electrodes.

In many embodiments, multiple layers of materials may be laminated together in successive lamination operations, while other embodiments may laminate three, four, or more layers of material in a single step.

FIG. 10 is a flowchart diagram of an embodiment 1000 showing a method for manufacturing a porous material that may be used as a separator material. Embodiment 1000 is a general method, examples of which are discussed below.

In block 1002, a solution may be formed with a polymer dissolved in a first liquid and a second liquid that may act as a pore forming agent. The liquids may be selected based on boiling points or volatility and surface tension so that when processed, the polymer is formed with a high porosity. Examples of such liquids are discussed below.

After forming the solution in block 1002, the solution is applied to a carrier in block 1004. The carrier may be any type of material. In some cases, a flat sheet of porous material may be cast onto a table top, which acts as a carrier in a batch process. In other cases, a film such as a polymer film, treated or untreated kraft paper, aluminum foil, or other backing or carrier material may be used in a continuous process. In such cases, a porous film may be manufactured and attached to a reinforcing web in a secondary process. In still other cases, the carrier material may be a nonwoven, woven, perforated, or other reinforcing web. In such cases, the solution may be applied by dipping, spraying, casting, extruding, pouring, spreading, or any other method of applying the solution.

The reinforcing web may be any type of reinforcement, including polymer based nonwoven webs, paper products, and fiberglass. In some cases, a woven material may be used with natural or manmade fibers, while in other cases, a solid film may be perforated and used as a reinforcing web.

In block 1006, enough of the primary liquid may be removed so that the dissolved polymer may begin to gel. In some embodiments, some, most, or substantially all of the primary liquid may be removed in block 1006. As the polymer begins to gel, the mechanical structure of the material may begin to take shape and the porosity may begin to form. During this time, the material may have some mechanical properties so that different mechanisms may be used to remove any remaining primary liquid and the secondary liquid.

The secondary liquid may be removed in block 1008. During the gelling process of block 1006, the differences in surface tension between the various materials may allow the secondary liquid to coalesce and form droplets, around which the polymer may gel as the first liquid is removed. After or as the polymer solidifies, the second liquid may be removed. In some cases, the boiling point or volatility of the two liquids may be selected so that the primary liquid evaporates prior to the secondary liquid.

The mechanisms for removing the primary and secondary liquids may be any type of suitable mechanism for removing a liquid. In many cases, the primary liquid may be removed by a unidirectional mass transfer mechanism such as evaporation, wicking, blotting, mechanical compression or others. Some methods may use bidirectional mass transfer such as rinsing or washing. In some cases, one method may be used to remove the primary liquid and a second method may be used for the secondary liquid. For example, the primary liquid may be at least partially removed by evaporation while the remaining primary liquid and secondary liquid may be removed by rinsing or mechanically squeezing the material.

Three embodiments are presented below of formulations and methods of production for porous material.

In a first embodiment, the porous material may be formed by first forming a layer of a polymer solution on a substrate, wherein the polymer solution may comprise two miscible liquids and a polymer material dissolved therein, wherein the two miscible liquids may comprise (i) a principal solvent liquid that may have a surface tension at least 5% lower than the surface energy of the polymer and (ii) a second liquid that may have a surface tension at least 5% greater than the surface energy of the polymer. Second, a gelled polymer may be produced from the layer of polymer solution under conditions sufficient to provide a non-wetting, high surface tension solution within the layer of polymer solution; and, thirdly, rapidly removing the liquid from the film of gelled polymer by unidirectional mass transfer without dissolving the gelled polymer to produce the strong, highly porous, microporous polymer 102 and 104.

In a second embodiment, the porous material 104 may be produced using a method comprising:

(i) preparing a solution of one or more polymers in a mixture of a principal liquid which is a solvent for the polymer and a second liquid which is miscible with the principal liquid, wherein (i) the principal liquid may have a surface tension at least 5% lower than the surface energy of the polymer, (ii) the second liquid may have a surface tension at least 5% higher than the surface energy of the polymer, (iii) the normal boiling point of the principal liquid is less than 125° C. and the normal boiling point of the second liquid is less than about 160° C., (iv) the polymer may have a lower solubility in the second liquid than in the principal liquid, and (v) the solution may be prepared at a temperature less than about 20° C. above the normal boiling point of the principal liquid and while precluding any substantial evaporation of the principal liquid;

(ii) reducing the temperature of the solution by at least 5° C. to a temperature between the normal boiling point of the principal liquid and the temperature of the substrate upon the solution is to be cast;

(iii) casting the polymer solution onto a high surface energy substrate to form a liquid coating thereon, said substrate having a surface energy greater than the surface energy of the polymer; and

(iv) removing the principal liquid and the second liquid from the coating by unidirectional mass transfer without use of an extraction bath, (ii) without re-dissolving the polymer, and (iii) at a maximum air temperature of less than about 100° C. within a period of about 5 minutes, to form the strong, highly porous, thin, symmetric polymer membrane.

In a third embodiment, the porous material 104 may be produced by a method comprising:

(i) dissolving about 3 to 20% by weight of a polymer in a heated multiple liquid system comprising (a) a principal liquid which is a solvent for the polymer and (b) a second liquid to form a polymer solution, wherein (i) the principal liquid may have a surface tension at least 5% lower than the surface energy of the polymer, (ii) the second liquid may have a surface tension at least 5% greater than the surface energy of the polymer; and (iii) the polymer may have a lower solubility in the second liquid than it has in the principal solvent liquid;

(ii) reducing the temperature of the solution by at least 5° C. to between the normal boiling point of the principal liquid and the temperature of the substrate upon which it will be cast;

(iii) casting a film of the fully dissolved solution onto a substrate which may have a higher surface energy than the surface energy of the polymer;

(iv) precipitating the polymer to form a continuous gel phase while maintaining at least 70% of the total liquid content of the initial polymer solution, said precipitation caused by a means selected from the group consisting of cooling, extended dwell time, solvent evaporation, vibration, or ultrasonics; and

(v) removing the residual liquids without causing dissolution of the continuous gel phase by unidirectional mass transfer without any extraction bath, at a maximum film temperature which is less than the normal boiling point of the lowest boiling liquid, and within a period of about 5 minutes, to form a strong, highly porous, thin, symmetric polymer membrane.

The preceding embodiments are examples of different methods by which a porous material may be formed from a liquid solution to a porous polymer. Different embodiments may be used to create the porous material 102 and 104 and such embodiments may contain additional steps or fewer steps than the embodiments described above. Other embodiments may also use different processing times, concentrations of materials, or other variations.

Each of the embodiments of porous material 102 and 104 may begin with the formation of a solution of one or more soluble polymers in a liquid medium that comprises two or more dissimilar but miscible liquids. To form highly porous products, the total polymer concentration may generally be in the range of about 3 to 20% by weight. Lower polymer concentrations of about 3 to 10% may be preferred for the preparation of membranes having porosities greater than 70%, preferably greater than 75%, and most preferably greater than 80% by weight. Higher polymer concentrations of about 10 to 20% may be more useful to prepare slightly lower porosity membranes, i.e. about 60 to 70%.

A suitable temperature for forming the polymer solution may generally range from about 40° C. up to about 20° above the normal boiling point of the principal liquid, preferably about 40 to 80° C., more preferably about 50° C. to about 70° C. A suitable pressure for forming the polymer solution may generally range from about 0 to about 50 psig. In some embodiments, the polymer solution may be formed in a vacuum. Preferably a sealed pressurized system is used.

The material 102 may be formed in the presence of at least two dissimilar but miscible liquids to form the polymer solution from which a polymer film may be cast. The first “principal” liquid may be a better solvent for the polymer than the second liquid and may have a surface tension at least 5%, preferably at least 10%, lower than the surface energy of the polymer involved. The second liquid may be a solvent or a non-solvent for the polymer and may have a surface tension at least 5%, preferably at least 10%, greater than the surface energy of the polymer.

The principal liquid may be at least 70%, preferably about 80 to 95%, by weight of the total liquid medium. The principal liquid may dissolve the polymer at the temperature and pressure at which the solution may be formed. The dissolution may generally take place near or above the boiling temperature of the principal liquid, usually in a sealed container to prevent evaporation of the principal liquid. The principal liquid may have a greater solvent strength for the polymer than the second liquid. Also, the principal liquid may have a surface tension at least about 5%, preferably at least about 10%, lower than the surface energy of the polymer. The lower surface tension may lead to better polymer wetting and hence greater solubilizing power.

The second liquid, which may generally represent about 1 to 10% by weight of the total liquid medium, may be miscible with the first liquid. The second liquid may or may not dissolve the polymer as well as the first liquid at the selected temperature and pressure. The second liquid may have a higher surface tension than the surface energy of the polymer. Preferably, the second liquid may or may not wet the polymer at the gelation temperature though it may wet the polymer at more elevated temperatures.

Table A and Table B identify some specific principal and second liquids that may be used with typical polymers, especially including PVDF. Table A lists liquids that have at least some degree of solubility towards PVDF (surface energy of 35 dyne/cm), which may produce the dissolved polymer solution in the first step of the process. Ideally, a liquid may be selected from Table A that has solubility limits between 1% and 50% by weight of polymer at a temperature within the range of about 20 and 90° C. The liquids in Table B, on the other hand, may have lower polymer solubility than those in Table A, but may be selected because they have a higher surface tension than both the principal liquid and the polymers that may be dissolved in the solution made with liquid(s) from Table A.

Tables A and B represent typical examples of suitable liquids that may be used to create a porous material 102 and 104. Other embodiments may use different liquids as a principal liquid or second liquid.

Examples of suitable liquids for use as the principal liquid, along with their boiling point and surface tensions are provided in Table A below. The table is arranged in order of increasing boiling point, which is a useful parameter for achieving rapid gelling and removal of the liquid during the film formation step. In some applications, a lower boiling point may be preferred.

TABLE A

| | Normal | Surface |
|---|---|---|
| Principal Liquid | Boiling Point, EC | Energy, dynes/cm |
| methyl formate | 31.7 | 24.4 |
| acetone (2-propanone) | 56 | 23.5 |
| methyl acetate | 56.9 | 24.7 |
| Tetrahydrofuran | 66 | 26.4 |
| ethyl acetate | 77 | 23.4 |
| methyl ethyl ketone (2-butanone) | 80 | 24 |
| Acetonitrile | 81 | 29 |
| dimethyl carbonate | 90 | 31.9 |
| 1,2-dioxane | 100 | 32 |
| Toluene | 110 | 28.4 |
| methyl isobutyl ketone | 116 | 23.4 |

Examples of suitable liquids for use as the second liquid, along with their boiling point and surface tensions are provided in Table B below. This table is arranged in order of increasing surface tension as higher surface tension may result in optimum pore size distributions during the gelling and liquid removal steps of the process.

TABLE B

| | Normal boiling | Surface Energy, |
|---|---|---|
| Second Liquid | point, ° C. | dynes/cm |
| nitromethane | 101 | 37 |
| bromobenzene | 156 | 37 |
| formic acid | 100 | 38 |
| pyridine | 114 | 38 |
| ethylene bromide | 131 | 38 |
| 3-furaldehyde | 144 | 40 |
| bromine | 59 | 42 |
| tribromomethane | 150 | 42 |
| quinoline | 24 | 43 |
| nitric acid (69%) | 86 | 43 |
| water | 100 | 72.5 |

The porous material may be formed by using a liquid medium for forming the polymer solution. The liquid medium may be rapidly removable at a sufficiently low temperature so that the second liquid may be removed without re-dissolving the polymer during the liquid removal process. The liquid medium may or may not be devoid of plasticizers. The liquids that form the liquid medium may be relatively low boiling point materials. In many embodiments, the liquids may boil at temperatures less than about 125° C., preferably about 100° C. and below. Somewhat higher boiling point liquids, i.e. up to about 160° C., may be used as the second liquid if at least about 60% of the total liquid medium is removable at low temperature, e.g. less than about 50° C. The balance of the liquid medium can be removed at a higher temperature and/or under reduced pressure. Suitable removal conditions depend upon the specific liquids, polymers, and concentrations utilized.

Preferably the liquid removal may be completed within a short period of time, e.g. less than 5 minutes, preferably within about 2 minutes, and most preferably within about 1.5 minutes. Rapid low temperature liquid removal, preferably using air flowing at a temperature of about 80° C. and below, most preferably at about 60° C. and below, without immersion of the membrane into another liquid has been found to produce a membrane with enhanced uniformity. The liquid removal may be done in a tunnel oven with an opportunity to remove and/or recover flammable, toxic or expensive liquids. The tunnel oven temperature may be operated at a temperature less than about 90° C., preferably less than about 60° C. In some embodiments, the tunnel oven temperature may be 250 F. or higher.

The polymer solution may become supersaturated in the process of film formation. Generally cooling of the solution will cause the supersaturation. Alternatively, the solution may become supersaturated after film formation by means of evaporation of a portion of the principal liquid. In each of these cases, a polymer gel may be formed while there is still sufficient liquid present to generate the desired high void content in the resulting polymer film when that remaining liquid is subsequently removed.

After the polymer solution has been prepared, it may then be formed into a thin film. The film-forming temperature may be preferably lower than the solution-forming temperature. The film-forming temperature may be sufficiently low that a polymer gel may rapidly form. That gel may then be stable throughout the liquid removal procedure. A lower film-forming temperature may be accomplished, for example, by pre-cooling the substrate onto which the solution is deposited, or by self-cooling of the polymer solution by controlled evaporation of a small amount of the principal liquid.

The film-forming step may occur at a lower temperature (and often at a lower pressure) than the solution-forming step. Commonly, it may occur at or about room temperature. However, it may occur at any temperature and pressure if the gelation of the polymer is caused by means other than cooling, such as by slight drying, extended dwell time, vibrations, or the like. Application as a thin film may allow the polymer to gel in a geometry defined by the interaction of the liquids of the solution.

The thin film may be formed by any suitable means. Extrusion or flow through a controlled orifice or by flow through a doctor blade may be commonly used. The substrate onto which the solution may be deposited may have a surface energy higher than the surface energy of the polymer. Examples of suitable substrate materials (with their surface energies) include copper (44 dynes/cm), aluminum (45 dynes/cm), glass (47 dynes/cm), polyethylene terephthalate (44.7 dynes/cm), and nylon (46 dynes/cm). In some cases a metal, metalized, or glass surface may be used. More preferably the metalized surface is an aluminized polyalkylene such as aluminized polyethylene and aluminized polypropylene.

In view of the thinness of the films, the temperature throughout may be relatively uniform, though the outer surface may be slightly cooler than the bottom layer. Thermal uniformity may enable the subsequent polymer precipitation to occur in a more uniform manner.

The films may be cooled or dried in a manner that prevents coiling of the polymer chains. Thus the cooling/drying may be conducted rapidly, i.e. within about 5 minutes, preferably within about 3 minutes, most preferably within about 2 minutes, because a rapid solidification of the spread polymer solution facilitates retention of the partially uncoiled orientation of the polymer molecules when first deposited from the polymer solution.

The process may entail producing a film of gelled polymer from the layer of polymer solution under conditions sufficient to provide a non-wetting, high surface tension solution within the layer of polymer solution. Preferably gelation of the polymer into a continuous gel phase occurs while maintaining at least 70% of the total liquid content of the initial polymer solution. More particularly, the precipitation of the gelled polymer is caused by a means selected from a group consisting of cooling, extended dwell time, solvent evaporation, vibration, or ultrasonics. Then, the balance of the liquids may be removed by a unidirectional process, usually by evaporation, from the formed film to form a strong micro-porous membrane of geometry controlled by the combination of the two liquids in the medium. In some embodiments, a liquid bath may be used to extract the liquids from the membrane. In other embodiments, the liquid materials may evaporate at moderate temperatures, i.e. at a temperature lower than that used for the polymer dissolution to prepare the polymer solution. The reduced temperature may be accomplished by the use of cool air or even the use of forced convection with cool to slightly warmed air to promote greater evaporative cooling.

The interaction among the two liquids (with their different surface tension characteristics) and the polymer (with a surface energy intermediate the surface tensions of the liquids) may yield a membrane with high porosity and relatively uniform pore size throughout its thickness. The surface tension forces may act at the interface between the liquids and the polymer to give uniformity to the cell structure during the removal step. The resulting product may be a solid polymeric membrane with relatively high porosity and uniformity of pore size. The strength of the membrane in some embodiments may be surprisingly high, due to the more linear orientation of polymer molecules.

The ratio of the principal liquid to the second liquid at the point of gelation may be adjusted such that the surface tension of the composite liquid phase may be greater than the surface energy of the polymer. The calculation of the composite liquid surface tension can be predicted based upon the mol fractions of liquids, as defined in “Surface Tension Prediction for Liquid Mixtures,” AIChE Journal, vol 44, no. 10, p. 2324, 1998, the subject matter of which is incorporated herein by reference.

Thermodynamic calculations show that adiabatic cooling of a solution can be significant initially and that the temperature gradient through such a film is very small. The latter may be considered responsible for the exceptional uniformity obtained using these methods.

The polymers used to produce the microporous membranes of the present invention may be organic polymers. Accordingly, the microporous polymers comprise carbon and a chemical group selected from hydrogen, halogen, oxygen, nitrogen, sulfur and a combination thereof. In a preferred embodiment, the composition of the microporous polymer may include a halogen. Preferably, the halogen is selected from the group consisting of chloride, fluoride, and a mixture thereof.

Suitable polymers for use herein may be include semi-crystalline or a blend of at least one amorphous polymer and at least one crystalline polymer.

Preferred semi-crystalline polymers may be selected from the group consisting of polyvinylidene fluoride, polyvinylidene fluoride-hexafluoropropylene copolymer, polyvinyl chloride, polyvinylidene chloride, chlorinated polyvinyl chloride, polymethyl methacrylate, and mixtures of two or more of these semi-crystalline polymers.

In some embodiments, the products produced by the processes described herein may be used as a battery separator. For this use, the polymer may comprise a polymer selected from the group consisting of polyvinylidene fluoride (PVDF), polylvinylidene fluoride-hexafluoropropylene copolymer (PVDF-HFP), polyvinyl chloride, and mixtures thereof. Still more preferably the polymer may comprise at least about 75% polyvinylidene fluoride.

The “MacMullin” or “McMullin” Number measures resistance to ion flow is defined in U.S. Pat. No. 4,464,238, the subject matter of which is incorporated herein by reference. The MacMullin Number is “a measure of resistance to movement of ions. The product of MacMullin Number and thickness defines an equivalent path length for ionic transport through the separator. The MacMullin Number appears explicitly in the one-dimensional dilute solution flux equations which govern the movement of ionic species within the separator; it is of practical utility because of the ease with which it is determined experimentally.” The lower a MacMullin Number the better for battery separators, the better. Products using these techniques may have a low MacMullin number, i.e. about 1.05 to 3, preferably about 1.05 to less than 2, most preferably about 1.05 to about 1.8.

Good tortuosity is an additional attribute of some embodiments. A devious or tortuous flow path with multiple interruptions and fine pores may act as a filter against penetration of invading solids. Tortuosity of the flow path can be helpful to prevent penetration by loose particles from an electrode or to minimize growth of dendrites through a separator that might cause electrical shorts. This characteristic cannot be quantified, except by long-term use, but it can be observed qualitatively by viewing a cross-section of the porosity using scanning electron microscopy.

Some embodiments may be generally uniform and symmetric, i.e. the substrate side pores may be substantially similar in size to the central and the air side pores. Pores varying in diameter by a factor of about 5 or less may be sufficiently uniform for the membranes to function in a symmetric manner.

Where additional strength or stiffness may be needed for handling purposes, micro- or nano-particles can be added to the formulation with such particulates residing within the polymer phase. A few such additives include silica aerogel, talc, and clay.

For the purposes of this specification and claims, a high porosity PVDF film may be a microporous membrane node of polyvinylidene fluoride and/or a copolymer of vinylidene fluoride with hexafluoropropylene. Typical embodiments may have a thickness between 5 and 200 microns and a void fraction between 0.40 and 0.90. Other embodiments may be thicker or thinner, and may have a higher or lower void fraction.

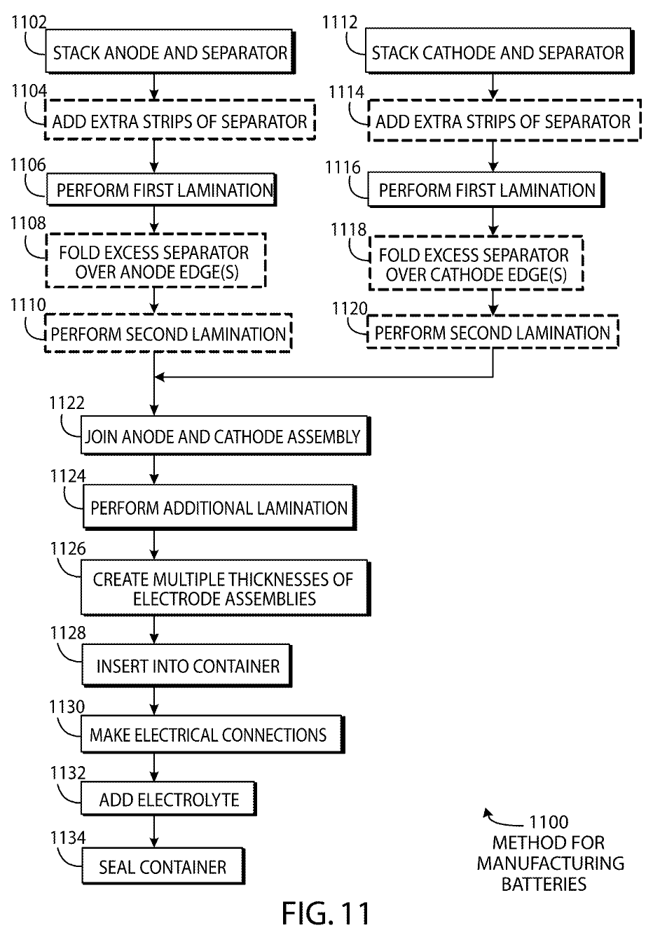

FIG. 11 is a flowchart illustration of an embodiment 1100 showing a method for manufacturing batteries. Embodiment 1100 is a simplified example of a manufacturing process that may be used with the separator and electrode configurations described above.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 1100 is a simplified assembly sequence for a battery. Two intermediate assemblies are created: one for the anode and one for the cathode. The intermediate assemblies may have a separator laminated to the electrode and may have additional pieces of separator material and may also have portions of the separator material that are folded over the edges of the electrode. After the intermediate assemblies are constructed, the intermediate assemblies may be constructed into a battery.

In block 1102, the anode and separator may be stacked together. In some embodiments, a single separator may be stacked with an anode, such as in embodiments 100, 200, 300, 500, 700, and 800. In other embodiments, two separators may be stacked with an anode, such as in embodiments 400 and 600.

In block 1104, any extra strips of separator may be added to the stack. The extra strips may be strips as described in embodiment 300 and 600. Some embodiments may have no extra strips of separator material.

In block 1106, a first lamination operation may be performed. In some cases, the lamination operation of block 1106 may be performed by mechanically pressing the laminate stack with or without applying heat. One mechanism for applying heat may be to use heated rollers. Other mechanisms may include applying heat to the mating surfaces of the laminate parts, such as by hot air or using some other medium.

In some embodiments, a continuous lamination process may join the separator material to the anode across a large portion of the interface between the anode and separator. Such processes may laminate 50%, 60%, 75% or more of the surface area between the two laminates.

In some embodiments, the lamination process may join the separator material to the anode across a small portion of the interface between the anode and separator. Such processes may laminate 20%, 10%, 5%, 1%, or less of the surface area between the two laminates.

Some embodiments may use a discontinuous lamination process. A discontinuous lamination process may laminate using spots, circles, or other patterns or lamination between the laminates.

In block 1108, excess separator material may be folded over an edge of the anode. Examples of folded separator material embodiments include embodiment 200, 300, 400, and 500. The folded laminate may be laminated a second time in block 1110.

Blocks 1102 through 1110 illustrate a method for constructing an intermediate assembly for an anode. Blocks 1112 through 1120 illustrate the same steps as blocks 1102 through 1110 but applied to a cathode. The same manufacturing steps that are described for an anode intermediate assembly may be applied to a cathode intermediate assembly.

The anode and cathode assemblies may be joined in block 1122. In some embodiments, an additional lamination process may be performed in block 1124 between the two intermediate assemblies.

In block 1126, multiple thicknesses of the electrode assemblies may be created. In a cylindrical or wound battery configuration, the anode and cathode intermediate assemblies may be wound around a mandrel. In a flat battery assembly, multiple layers of anode and cathodes may be stacked together.

The multiple thicknesses of electrode assemblies may be placed in a container in block 1128. While many different mechanical configurations are possible, a cylindrical battery container may be a cylindrical tube that is closed at one end. A flat battery container may be a solid or flexible container that may hold the anode and cathode assemblies together.

After mounting the assemblies in a container, electrical connections may be made between the anode and cathode and the exterior contacts of the battery package in block 1130.

In block 1132, an electrolyte may be added to the container and the container may be sealed in block 1134.

The precise sequence of the process of embodiment 1100 may be different for different battery configurations and different battery chemistries. In many embodiments, a lithium ion or lithium based battery chemistry may be used, although other types of battery chemistries may also be used, such as lithium metal, lead-acid, fuel cells, capacitors, alkaline cells, and other electrochemistries.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. An intermediate assembly for a battery comprising:
a battery electrode for a battery, said battery electrode having an electrode width;
a first battery separator comprising a high porosity PVDF film, said battery separator having a separator width and having laminations to said battery electrode across a portion of said electrode width.

2. The assembly of claim 1, said laminations being discontinuous.

3. The assembly of claim 1, said laminations being continuous.

4. The assembly of claim 3, said laminations being across at least 50% of said electrode width.

5. The assembly of claim 3, said laminations being across no more than 20% of said electrode width.

6. The assembly of claim 1, said intermediate assembly being usable for a wound battery configuration.

7. The assembly of claim 6, said intermediate assembly further comprising:
a second battery separator being folded over one edge of said battery electrode.

8. The assembly of claim 7, said one edge being a leading edge of said assembly configured to be fed into a winding apparatus.

9. The assembly of claim 7, said one edge being an edge perpendicular to a winding axis when said assembly is fed into a winding apparatus.

10. The assembly of claim 1, said first battery separator being folded over a first edge of said battery electrode to form an overlap width.

11. The assembly of claim 10, said first edge being a leading edge of said assembly configured to be fed into a winding apparatus.

12. The assembly of claim 10, said first edge being an edge perpendicular to a winding axis when said assembly is fed into a winding apparatus.

13. The assembly of claim 1, said battery being a lithium ion battery.

14. A method comprising:
laminating a battery anode to a first battery separator, said first battery separator comprising a high porosity PVDF film to form a first intermediate assembly;
laminating a battery cathode to a second battery separator, said second battery separator comprising a high porosity PVDF film to form a second intermediate assembly; and
joining said first intermediate assembly and said second intermediate assembly into a battery assembly.

15. The method of claim 14, said joining comprising:
stacking said first intermediate assembly and said second intermediate assembly into a stack; and
winding said stack around a mandrel.

16. The method of claim 15 further comprising:
laminating said stack.

17. The method of claim 14 further comprising:
wrapping a portion of said first battery separator around an edge of said anode.

18. The method of claim 14 further comprising:
wrapping a portion of said second battery separator around an edge of said cathode.

19. A battery as a product of the process comprising: laminating a battery anode to a first battery separator, said first battery separator comprising a high porosity PVDF film to form a first intermediate assembly;
laminating a battery cathode to a second battery separator, said second battery separator comprising a high porosity PVDF film to form a second intermediate assembly; and
joining said first intermediate assembly and said second intermediate assembly into a battery assembly.

20. The battery of claim 19, said process further comprising:
folding a portion of said first battery separator over an edge of said battery anode; and
folding a portion of said second battery separator over an edge of said battery cathode.
